(19) United States
(12) Patent Application Publication
(10) Pub. No.: US 2009/0090743 A1
(43) Pub. Date: Apr. 9, 2009

(54) Ejection device

(76) Inventors: Peter Ostermeier, Diessen (DE); Franz Heiberger, Stettfurt (CH); Ingo Loeschky, Kaufering (DE); Rainer Strobel-Schmidt, Bad Woerishofen (DE); Franz Popp, Buchloe (DE); Martin Kuhn, Germering (DE); Hans Peter Lederle, Durach (DE); Christian Hefele, Breitenbrunn (DE)

Correspondence Address: ABELMAN, FRAYNE & SCHWAB, 666 THIRD AVENUE, 10TH FLOOR, NEW YORK, NY, 10017, US

(21) Appl. No.: 12/287,369

(22) Filed: Oct. 7, 2008

(30) Foreign Application Priority Data
Oct. 9, 2007 (DE) 10 2007 000 838.6

(51) Int. Cl. B67D 5/52; B65D 88/54

(52) U.S. Cl. 222/137; 222/326

(57) ABSTRACT

An ejection device (11) has an ejection unit (12) having a displacement mechanism with two piston rods (13), a receptacle unit (32) including receptacle (34) for a container (33), a head part for limiting the receptacle (34) at one of its ends, a holding device (21) which is arranged on the ejection unit (12) for securing the receptacle unit (32) thereto, and tension members (38) provided on the receptacle unit (32) and which extend along the receptacle (34) and are secured to the head part (35), each tension member (38) having a engageable-from behind section (39) at its end remote of the head part, the holding device (21) having locking elements which can engage the engageable-from behind sections (39) of the tension members (38) to lock the receptacle unit (32) with the ejection unit (12).

### BACKGROUND OF THE INVENTION

1. Field of the Invention

The invention relates to an ejection device with an ejection unit having a displacement mechanism having at least one piston rod, and with a receptacle unit with a receptacle for a container which can be ejected by the at least one piston rod. The receptacle is limited at one end by a head part and releasably secured to the ejection unit by a holding device which is arranged at the ejection unit.

2. Description of the Prior Art

An ejection device of the type mentioned above is used for dispensing, at an application site, compounds, such as mortar compounds or sealing compounds which are packaged in containers, e.g., foil bags or cartridges. The at least one piston rod is displaced by a predetermined extent by actuating the displacement mechanism, and a pressure plate, which is arranged at the piston rod, acts on the container and a corresponding amount of the compound contained therein is dispensed through an outlet opening in the head part.

EP 0 543 776 A1 discloses an ejection device having an ejection unit with a displacement mechanism with two piston rods, and a receptacle unit with a receptacle for a cartridge that can be squeezed out by the piston rods. The receptacle is limited at one end by a head part and has an end remote of the head part. The receptacle unit is detachably fixed to the ejection unit by a holding device which is arranged on the ejection unit. A flange is provided at the end remote of the head part and engages in three grooves at the ejection unit which are oriented in a U-shaped manner relative to one another. A snap lever, which is arranged at the ejection unit, engages behind the flange at its fourth side. The grooves and the snap lever form the holding device arranged on the ejection unit for detachably fixing the receptacle unit to the ejection unit and accordingly form an interface of the ejection device.

Various types and sizes of containers or cartridges can be fixed to an ejection unit.

The known solution is disadvantageous in that the design of the end of the receptacle in question is complicated. In ejection devices of the generic type, high forces act on the interface of the ejection device and, after a certain period of use, can lead to play in the connection between the ejection unit and the receptacle unit.

### SUMMARY OF THE INVENTION

It is the object of the invention to provide an ejection device with a detachable interface between the ejection unit and the receptacle unit which forms a reliable connection and has a long useful life.

This and other objects of the present invention, which will become apparent hereinafter, are achieved by providing, according to the invention, tension members on at the receptacle unit which extend along the receptacle and are secured to the head part. Each tension member has an engageable-from behind section at its end remote of the head part, and the holding device has locking means engageable with the tension members to lock the receptacle unit with the ejection unit.

The interface according to the invention is distinguished by a simple design and a reliable connection between the ejection unit and the receptacle unit. For example, different lengths of receptacle units for receiving different containers such as foil bags or cartridges can be detachably fixed to the ejection unit in a simple manner.

The tension members are advantageously formed as tie rods having a threaded portion at the end facing the head part. A clamping element, e.g., a nut, can be screwed on the threaded portion to secure the tie rods to the head part. A cartridge having at least one tubular receiving chamber for the compound to be ejected is advantageously received in the receptacle. When the receptacle unit is secured to the ejection unit, the cartridge advantageously contacts the head part of the receptacle unit and a stop face at the ejection unit and is held in the receptacle so as to be fixed with respect to axial displacement. The cartridge is advantageously held in the receptacle in a clamping manner.

The engageable-from behind sections of the tension members in combination with the locking means engaging behind the engageable-from behind sections ensure a connection without play, and the connection between the receptacle unit and the ejection unit is advantageously centered when locking. When unlocking the connection, the locking means release the engageable-from behind sections of the tension members again, and the receptacle unit can be removed from the ejection unit.

In an advantageous manner, the engageable-from behind sections of the tension members are eyelets, each with a engageable-from behind opening, and the locking means are locking hooks which can be pivoted around a pivot axis and which have locking sections which can be pivoted into the engageable-from behind openings of the eyelets for locking the receptacle unit with the ejection unit. The connection between the receptacle unit and the ejection unit is locked and unlocked by pivot the hooks around the pivot axis. When locking, the locking sections of the hooks penetrate into the engageable-from behind openings of the eyelets of the tie rods and ensure a reliable connection of the receptacle unit to the ejection unit without any play. When the locking hooks are pivoted in, the tension members are tightened in the direction of the ejection unit, which ensures that the container placed in the receptacle is securely held, particularly during the ejection process. When unlocking, the locking sections of the locking hooks pivot out of the engageable-from behind openings of the eyelets of the tension members so that the receptacle unit is uncoupled from the ejection unit.

A guide bevel is preferably provided at each of the locking hooks and the locking hooks are spring-biased in direction of the locking position. When the receptacle unit is joined with the ejection unit, the free ends of the eyelets at the tension members come into contact with the guide bevels of the respective locking hook and force it into a position in which the locking section of the locking hook can penetrate into the engageable-from behind openings of the eyelets for locking the receptacle unit with the ejection unit. The spring-biasing of the locking hooks ensures that the locking hooks which are pivoted when the receptacle unit is joined with the ejection unit arrive in a position in which they engage behind the engageable-from behind opening of the eyelet and automatically lock the receptacle unit with the ejection unit.

The holding device advantageously has an actuating element acting on the locking means for unlocking the receptacle unit from the ejection unit. When the actuating element is actuated, the locking means of the holding device disengage from the engageable-from behind sections of the tension members. The actuating element creates a quick-change fastening between the receptacle unit and the ejection unit.

Preferably, a transmitting member having transmission surfaces which can be brought into contact with the locking means is provided on the actuating element. The transmission surfaces are advantageously provided on a part of the transmitting member that projects perpendicular to the longitudinal extension of the tension members or to the longitudinal extent of the at least one piston rod. In a particularly advantageous manner, the transmitting member is formed as a U-shaped member and the transmission surfaces, which can be brought into contact with the locking means, are advantageously provided at the free end of the U-shaped transmitting member.

When the holding means has locking hooks which can be pivoted around a pivot axis and which have a locking section, the transmitting member of the actuating element advantageously acts on the locking hook between the pivot axis and the locking section to unlock the receptacle unit.

The actuating element is advantageously spring-biased and must be moved against the spring-biasing force of a spring element to unlock the receptacle unit from the ejection unit. After the actuating element is actuated, this actuating element returns to its initial position again in which the actuating element no longer acts on the locking means.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

In the following, the invention will be described more fully with reference to embodiment examples.

The drawings show:

FIG. 1 a perspective view of an ejection device according to the present invention;

FIG. 2 a partial, perspective view of the interface between the receptacle unit and the ejection unit in the locked condition; and

FIG. 3 a partial, perspective view of the interface shown in FIG. 2 between the receptacle unit and the ejection unit in the unlocked condition.

In principle, identical parts are provided with identical reference numerals in the drawings.

### DETAILED DESCRIPTION OF THE PREFERRED EMBODIMENT

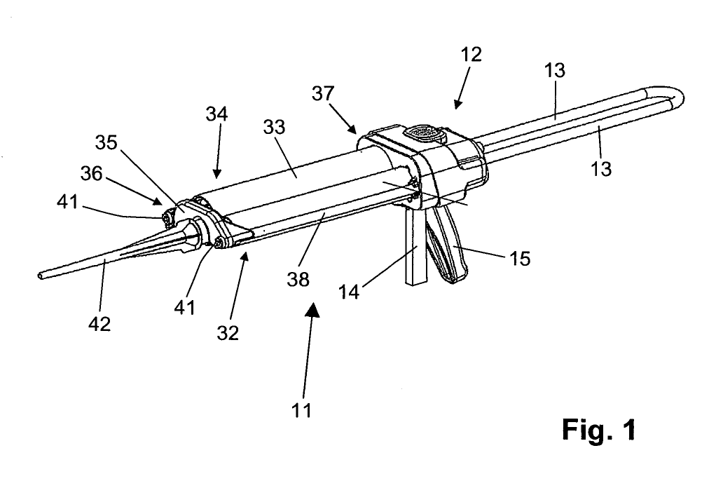

The ejection device 11 shown in FIGS. 1 to 3 has an ejection unit 12 and a receptacle unit 32 with a receptacle 34 for a container 33. The container 33 is a multi-chamber cartridge with two tubular receptacles arranged next to one another for directly receiving the compound to be ejected or for indirectly receiving the compound to be ejected, this compound being available to the user in foil bag packaging. The ejection unit 12 has a displacement mechanism with two piston rods 13 provided with pressure plates at their free ends. The displacement mechanism is actuated by a hand-operated lever 14 at a handle 15, and the piston rod 13 is displaced in direction of the receptacle unit 32 by a distance determined by the displacement mechanism.

The receptacle 34 of the receptacle unit 32 is limited at one end 36 by a head part 35 and has an end 37 which is remote of the head part 35. The head part 35 has an outlet opening with a dispensing nozzle 42 in which a mixing element is provided for the compound to be ejected from the container 33. Two tie rods acting as tension members 38, which extend along the receptacle 34, are provided at the sides of the receptacle unit 32, each having a engageable-from behind section 39 at their end remote of the head part 35. The engageable-from behind sections 39 of the tension members 38 are formed as eyelets 40, each with a engageable-from behind opening 43. The tension members 38 have, respectively, threaded portions at the end in the region of the head part 35 and are secured to the head part 35 by nuts 41.

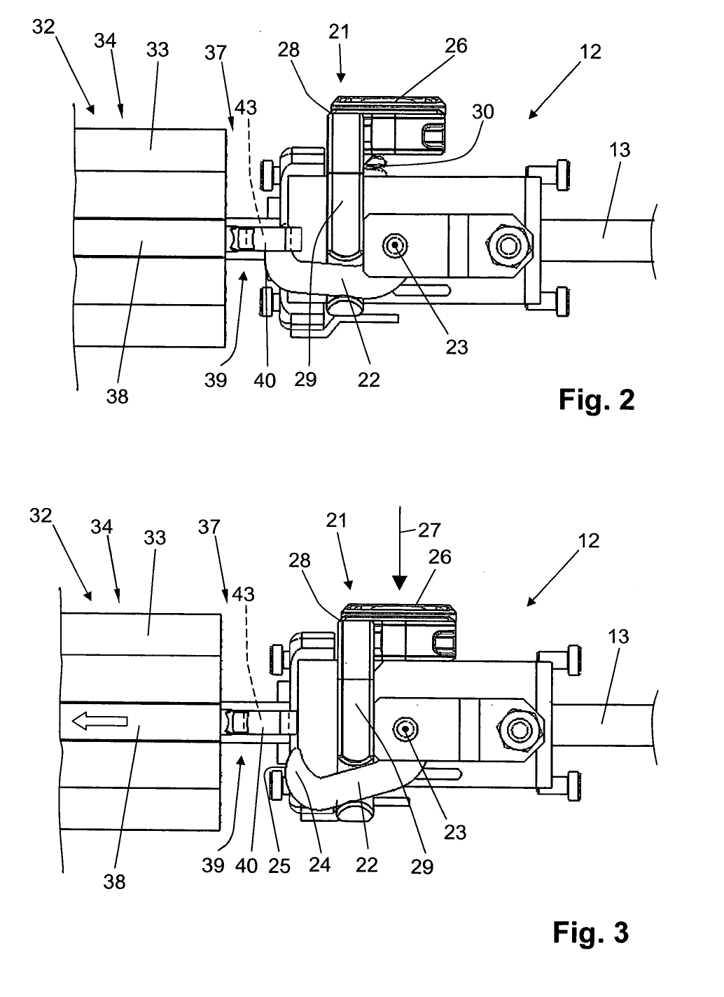

The receptacle unit 32 is detachably fixed to the ejection unit 12 by a holding device 21 arranged at the ejection unit 12. The holding device 21 has, as locking means, locking hooks 32 which are pivotal around a pivot axis 23 and which have locking sections 24 that engage behind the engageable-from behind openings 43 of the eyelets 40 to lock the receptacle unit 32 with the ejection unit 12. The eyelets 40 form the engageable-from behind sections 39 of the tension members 38. The locking sections 24 can be pivoted into the engageable-from behind openings 43 of the eyelets 40. The locking hooks 22 each have a guide bevel 25 and are spring-biased in direction of the locking position (see FIG. 2).

Further, the holding device 21 has an actuating element 26 which acts on the locking means and which has a U-shaped transmitting member 28 for unlocking the receptacle unit 32 from the ejection unit 12. By pressing on the actuating element 26 in direction of the arrow 27, the free ends 29 of the transmitting member 28 act between the pivot axis 23 and the locking section 24 on the locking hooks 22 so that the latter is pivoted against spring-biasing force, and the receptacle unit 32 is uncoupled from the ejection unit 12 (see FIG. 3). The actuating element 26 is acted upon by a spring element 30 which brings the actuating element 26 into its initial position in the direction opposite that of arrow 27 after pressure is relaxed.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An ejection device, comprising an ejection unit (12) including a displacement mechanism having at least one piston rod (13); receiving means (32) including a receptacle (34) for receiving a container (33) ejectable with the at least one piston rod (13), a head part (35) for limiting the receptacle (34) at one end (36) thereof, and tensioning members (38) extending along the receptacle (34), secured to the head part (35), and each provided, at an end thereof remote from the head part (35), with an engageable-from behind section (39); and a holding device (21) mounted on the ejection unit (12) for releasably securing the receiving means (32) to the ejection unit (12), the holding device (21) having locking means engageable with the engageable-from behind sections (39) of the tensioning members (38) for locking the receiving unit (32) with the ejection unit (12).

2. An ejection device according to claim 1, wherein the engageable-from behind section (39) of each of the tensioning members (38) has an eyelet (40) having an engageable-from behind opening, and the locking means of the holding device (21) comprises locking hooks (22) each having a locking section (24) and pivotable about a pivot axis (23) into a respective engageable-from behind opening of a respective eyelet (40) for locking the receiving unit (32) with the ejection unit (12).

3. An ejection device according to claim 2, wherein each of the locking hooks (23) has a guide inclination (25) and each is spring-biased in a locking position thereof.

4. An ejection device according to claim 1, wherein the holding device (21) has an actuation member (26) acting on the locking means for unlocking of the receiving unit (32) from the ejection unit (12).

5. An ejection device according to claim 4, wherein the actuation member (26) has a transmitting member (28) having transmitting surfaces that can be brought in abutment with the locking means.

6. An ejection device according to claim 4, wherein the actuation member (26) is spring-biased.
